(19) United States
(12) Patent Application Publication
(10) Pub. No.: US 2001/0014905 A1
(43) Pub. Date: Aug. 16, 2001

(54) Method and apparatus for managing a lock for an object

(76) Inventor: Tamiya Onodera, Ageo-shi (JP)

Correspondence Address: Kevin P. Radigan, Esq., HESLIN & ROTHENBERG, P.C., 5 Columbia Circle, Albany, NY, 12203, US

(21) Appl. No.: 09/738,165

(22) Filed: Dec. 15, 2000

(30) Foreign Application Priority Data
Dec. 27, 1999 (JP) 11-371730

(51) Int. Cl. G06F 9/00; G06F 9/46

(52) U.S. Cl. 709/102; 709/312

(57) ABSTRACT

An innovative compound lock method is provided that does not reduce the processing speed attained along a frequent path. When no thread is locking an object (1), a value of 0 is stored both in a lock field and in a contention bit. Then, when a specific thread locks an object (light lock), the identifier of the thread is stored in the lock field (2). If any other thread attempts to acquire a lock before the thread designated by the thread identifier unlocks the object, SPECIAL is stored in the lock field (5), and the process is returned to (1). If a different thread attempts to acquire a lock before the designated thread unlocks the object, this causes a contention to occur in the light lock mode, and a contention bit is set to record it (3). Thereafter, when the lock mode is shifted to the fat lock mode, the contention bit is cleared (4), and if possible, the process is shifted from (4) to (1).

### PRIOR FOREIGN APPLICATION

This application claims priority from Japanese patent application number 11-371730, filed Dec. 27, 1999, which is hereby incorporated herein by reference in its entirety.

### FIELD OF THE INVENTION

The present invention relates to a method and an apparatus for managing a lock for an object, and relates in particular to a method and an apparatus for managing a lock for an object in a state wherein a plurality of threads can exist.

### BACKGROUND ART

In order to synchronize the accessing of an object for a program that operates a plurality of threads, the program code is so designed that the object is first locked and then accessed and subsequently unlocked. Spin locks and queue locks (also called suspend locks) are well known as methods for implementing locks for objects. In addition, recently, combinations of these methods (hereinafter called compound locks) have also been proposed. These locking methods will now be briefly described.

### (1) Spin Lock

A spin locking system stores, into an object, the identifier of a thread that locks an object. According to the spin locking method, when a thread T fails to acquire a lock on an object obj, i.e., when another thread S already has a lock on the object obj, the locking procedure is repeated until it succeeds. Specifically, an atomic machine command (an indivisible command), such as compare#and#swap, is employed to lock or unlock an object in the following manner.

TABLE 1
10 /*lock*/
20 while (compare_and_swap(&obj−>lock,0,thread_id())= =0)
30 yield();
40 /*obj access*/
. . .
50 /*unlock*/
60 obj−>lock=0;

As is apparent from Table 1, locking is performed at the 20th and 30th lines, with yield() being repeated until a lock is acquired. The purpose of yield() is the halting of the execution of a current thread, and the shifting of control to a scheduler. Generally, the scheduler selects and operates one of the other executable threads; however, the scheduler eventually operates the original thread later, and until a lock is acquired a “while” statement is repetitively executed. If a “yield” is present, not only are CPU resources wasted, but also the implementation of the spin lock method has to depend on the scheduling method provided for a platform, so that it is difficult to write a desired program. The condition provided for the “while” statement on the 20th line, i.e., compare_and_swap, is the comparison of 0 with the contents of field obj→lock, which is prepared for the object obj, and the writing of a thread ID (thread_id()) to its field when the comparison result is true. Therefore, when 0 is stored in the field that is prepared for the object obj, the absence of a thread that has acquired a lock is indicated. Thus, when unlocking is performed on the 60th line, 0 is stored in the field obj→lock. This field is one word, for example, but in actuality, the number of bits that is required is only that which is needed to store a thread identifier.

### (2) Queue Lock

A queue lock system employs a queue to manage the threads that access an object. According to the queue lock method, when a thread T fails to lock an object obj, the thread T adds itself to the queue for obj, and is suspended. The unlocking code includes code for examining a queue to determine whether it is empty, whereafter, if it is determined the queue is not empty, one thread is extracted and the processing is resumed. A queue lock is implemented together with the scheduling mechanism for an operating system (OS), and is provided as the API (Application Programming Interface) for the OS. For example, a semaphore or a Mutex variable is a typical queue lock system. In a queue lock system, for space overhead one word is no longer adequate, and something less than 20 bytes is normally required. Further, since a common resource, i.e., a queue, is operated inside the lock or the unlock function, it should be noted that a specific lock is acquired or released.

### (3) Compound Lock

A program ready for multiple threads is written while taking into account the fact that it is to be executed by multiple threads, so that when a common resource is accessed the access is protected by a lock. However, a library ready for multiple threads may be used by a single-thread program, or lock contentions may seldom occur, even when a program is executed by multiple threads. Actually, according to a profile for the execution of Java programs (Java is a trademark of Sun Microsystems Corp.), for many applications, contentions related to object accessing seldom occur.

Therefore, the sequence “locking an object which is not locked, accessing the object and unlocking the object” is considered to be an execution path that is frequently followed. The functions encountered along this path are performed extremely efficiently by the spin lock system; while both in terms of time and space they are not efficiently performed by the queue lock system. However, when a contention actually does occur, which is not frequent, CPU resources are wasted if the spin lock system is used, whereas such waste does not occur if the queue lock system is employed.

The basic idea of the compound lock is that the functions encountered along the above frequently followed path be performed at a high speed by an appropriate combination of a lock method (called a light lock), such as the spin lock, for which a simple process is required and a lock method (called a fat lock), such as the queue lock, for which a complicated process is required, and that even upon the occurrence of a contention the efficiency of operation be maintained. Specifically, first, the light lock method is employed to acquire a lock, and then, when in the use of the light lock a contention occurs, the locking function is shifted to the fat lock method, which thereafter is employed.

According to the procedures employed for a compound lock, as well as for a spin lock, a lock field is prepared for an object, and a Boolean value is stored that indicates a value to be stored, either a “thread identifier” value or a “fat lock identifier” value.

The locking processing is performed as follows.

1) Acquisition of a light lock is attempted by an atomic command (e.g., compare_and_swap). If the lock is acquired, then object access is initiated. When the lock acquisition attempt fails, however, it is ascertained that the locking process has already been shifted to the fat lock method, or that, while the lock is still light, another thread has obtained a lock on the object.

2) If the lock is already fat, a fat lock is acquired.

3) When a contention occurs during the light lock process, a light lock is acquired, after which the process is shifted to the one for a fat lock, which is then acquired (in the following explanation, this process is performed by using an “inflate” function).

There are two kinds of implementation's for the compound lock system depending on whether or not “yield” is performed for “acquisition of the light lock” in 3). A detailed explanation for the implementations will be given below. It should be noted that the field for locking is one word, that to simplify the explanation the “thread identifier” and the “fat lock identifier” are always even numbers other than 0, and that the “thread identifier” is stored when the least significant bit of the lock field is 0, while the “fat lock identifier” is stored when the least significant bit is 1.

### Example Compound Lock 1

This is the compound lock system that performs “yield” for the acquisition of a light lock. The following lock function can be written in accordance with the above described processing.

TABLE 2

| | |
|---|---|
| 10: | void lock(obj){ |

| | |
|---|---|
| 20: | if (compare_and_swap(&obj−>lock,0,thread_id())) |

| | |
|---|---|
| 30: | return; |

| | |
|---|---|
| 40: | while (!(obj−>lock & FAT_LOCK)){ |
| 50: | |

| | |
|---|---|
| 60: | if (compare_and_swap(&obj−>lock,0,thread_id())){ |

| | |
|---|---|
| 70: | inflate(obj); |
| 80: | return; |

| | |
|---|---|
| 90: | } |
| 92: | yield(); |

| | |
|---|---|
| 100: | } |
| 110: | fat_lock(obj−>lock) |
| 120: | return; |

| | |
|---|---|
| 130: | } |
| 140: | |
| 150: | void unlock(obj){ |

| | |
|---|---|
| 160: | if (obj−>lock= =thread_id()) |

| | |
|---|---|
| 170: | obj−>lock=0; |

| | |
|---|---|
| 180: | else |

| | |
|---|---|
| 190: | fat_unlock(obj−>lock); |

| | |
|---|---|
| 200: | } |
| 220: | void inflate(obj){ |

| | |
|---|---|
| 230: | obj−>lock=alloc_fat_lock() \|FAT_LOCK; |
| 240: | fat_lock(obj−>lock); |

| | |
|---|---|
| 250: | } |

The 10th through the 130th lines of pseudo-code in Table 2 represent the lock function, the 150th through the 200th lines represent the unlock function, and the 220th through the 250th lines represent the inflate function used for the lock function. For the lock function, the light lock is attempted on the 20th line. If the light lock is acquired, the pertinent object is accessed. When the object is to be unlocked, since on the 160th line a thread identifier is entered in the lock field of the object, 0 is entered in the lock field on the 170th line. Therefore, the functions along the frequent path can be performed as fast as they are by the spin lock. When on the 20th line the lock can not be acquired, on the 40th line a check is performed to determine whether the condition for the “while” statement has been established. That is, a check is performed to determine whether the result obtained by ANDing the lock field and FAT_LOCK is 0, i.e., to determine whether the FAT_LOCK bit is 0 (more specifically, to determine whether the lock is a light lock). If this condition is established, “yield” is performed until the light lock is acquired on the 60th line. When the light lock has been acquired, the inflate function following the 220th line is executed. According to the inflate function, the fat lock identifier and the FAT_LOCK bit having a logical value of 1 are entered in the lock field obj→lock (230th line). Then, a fat lock is acquired (240th line). If on the 40th line the FAT_LOCK bit is already 1, a fat lock is immediately acquired (110th line). Then, on the 190th line, the fat lock is unlocked. It should be noted that the acquisition and the release of the fat lock is not closely related to the present invention, and no explanation for this process will be given.

It should be noted that in Table 2 the lock field is always rewritten by a thread that holds a light lock. This also applies for unlocking. The occurrence of “yield” is limited only at the time a contention for the light lock occurs.

### Example Compound Lock 2

A compound lock will now be explained wherein “yield” is not performed for the acquisition of a light lock. When a light lock is contended, the process waits for a thread. And when the light lock is released, the thread that is being waited for must be notified. A condition variable, a monitor or a semaphore is required for the wait and the notification. In the following explanation a monitor is employed.

TABLE 3

| | |
|---|---|
| 10: | void lock (obj){ |

| | |
|---|---|
| 20: | if (compare_and_swap(&obj−>lock,0,thread_id())) |

| | |
|---|---|
| 30: | return; |

| | |
|---|---|
| 40: | monitor_enter(obj); |
| 50: | while (!(obj−>lock,&FAT_LOCK)){ |

| | |
|---|---|
| 60: | if (compare_and_swap(&obj−>lock,0,thread_id())){ |

| | |
|---|---|
| 70: | inflate(obj); |
| 80: | monitor_exit(obj); |
| 90: | return; |

| | |
|---|---|
| 100: | } else |

| | |
|---|---|
| 110: | monitor_wait(obj); |

| | |
|---|---|
| 120: | } |
| 130: | monitor_exit(obj); |
| 140: | fat_lock(o−>look); |
| 150: | return; |

| | |
|---|---|
| 160: | } |
| 180: | void unlock(obj) |

| | |
|---|---|
| 190: | if (obj−>lock= =thread_id()){ |

| | |
|---|---|
| 200: | obj−>lock=0; |
| 210: | monitor_enter(obj); |
| 220: | monitor_notify(obj); |
| 230: | monitor_exit(obj); |

| | |
|---|---|
| 240: | } else |

| | |
|---|---|
| 250: | fat_unlock(obj−>lock); |

| | |
|---|---|
| 260: | } |
| 280: | void inflate(obj){ |

| | |
|---|---|
| 290: | obj−>lock=alloc_fat_lock() \| FAT_LOCK |
| 300: | fat_lock(obj−>lock); |
| 310: | monitor_notify_all(obj); |

| | |
|---|---|
| 320: | } |

The monitor, which is a synchronization mechanism that is devised by Hoare, enables exclusive control (“enter” and “exit”) for the accessing of an object, a thread waiting operation (“wait”) until a predetermined condition is established, and the transmission of a notification (“notify” or “notify all”) to a waiting thread (see Hoare, C.A.R. Monitors: An operating system structuring concept. Communications of ACM 17, 10 (Oct. 1974), 549-557). Using this mechanism, one thread at most is permitted to enter a monitor. If a specific thread S has already entered monitor m before a thread T attempts to enter it, the thread T must at least wait until the thread S has exited the monitor m. Exclusive control is achieved in this manner. Furthermore, while the thread T is in the monitor m it can wait until a specific condition is established. Specifically, then, the thread T implicitly exits the monitor m and enters a suspended state. It should be noted that since the thread T has implicitly exited the monitor m another thread can enter. On the other hand, when the thread S is in the monitor m it can transmit a notification to the monitor m after a specific condition has been established, and one of the threads that are waiting to enter the monitor m, in this case the thread U, is awakened. Accordingly, the thread U resumes the execution of its function and attempts implicitly to enter the monitor m. However, since the thread S is in the monitor m, the thread U must wait at least until the thread S exits the monitor m. When no waiting thread is present in the monitor m, no comparable process is performed. Note that “notify_all” is the same as “notify,” except that all the threads that are waiting are awakened.

In Table 3, the 10th through the 160th lines represent the lock function, the 180th through the 260th lines represent the unlock function, and the 280th through the 320th lines represent the inflate function. The differences between the lock function and the example compound lock 1 are that the thread enters the monitor on the 40th line, that when a contention occurs at the light lock the thread waits without yielding (110th line), and that the thread exits the monitor m when the lock is shifted to the fat lock (80th line) and this shift is confirmed (130th line). It should be noted that the thread exits the monitor on the 130th line, and the fat lock is acquired on the 140th line.

A difference between the unlock function and the example compound lock 1 is that, on the 210th through the 230th lines, a process is performed whereby the thread enters the monitor, transmits a notification to the monitor, and then exits the monitor. This is because the wait at the monitor is employed instead of “yield.” The code “notify_all” is added to the inflate function, also because the wait of the thread at the monitor is employed instead of “yield.” On the 290th line, the OR operation is performed for the fat lock identifier that is obtained by alloc_fat_lock() and the FAT_LOCK bit that is set to the logical value 1, and the obtained result is input to the lock field.

In Table 3, “yield” is eliminated; however, since a thread that is waiting for the unlock may be present, the notification (“notify”) is added, so that the performance of functions along the frequent path is reduced. Further, for spatial efficiency, an extra monitor or an extra function equivalent to the monitor is required, but when the lock is shifted to the fat lock, such a function is not necessary. That is, the monitor and the fat lock must be separately prepared.

A system using a shared memory model called a symmetrical multi-processor system (hereinafter referred to as an SMP system) is well known in an architecture that uses a shared memory model and that logically employs a common memory. In the SMP system, the order of the memory operations (Read and Write) are changed by required hardware in order to perform the parallel processing of instruction levels and to optimize the memory system. That is, for the memory operations performed by a processor P1 that executes program J, the observation order for another processor P2 is not always the same as the order designated by the program J. For example, an advanced architecture, such as PowerPC by IBM, Alpha by DEC, or Solaris RMO by Sun, does not guarantee the order of a program for all Read→Read, Read→Write, Write→Read and Write→Write operations.

However, a specific program may require that observation be performed in accordance with the order provided for the program. Thus, all of the above architectures provide some memory synchronization commands. For example, the PowerPC architecture includes the SYNC command as a memory synchronization command. When a programmer employs the command positively (directly), the arrangement of the memory operations by hardware can be limited. Since, however, the memory synchronization command generally carries a high overhead, its frequent use is not preferable.

In the SMP system, an explanation will be given for an example process that requires an observation in accordance with the order of the program.

### Example Compound Lock 3

TABLE 4

| | |
|---|---|
| 1: | void lock(Object*obj){ |
| 2: | /*acquisition of lock in light lock mode*/ |
| 3: | |
| 4: | if (compare_and_swap(&obj−>lock,0,thread_id())) |

| | |
|---|---|
| 5: | return; /*success*/ |
| 6: | |

| | |
|---|---|
| 7: | /*failure: enter monitor, shift to fat lock mode*/ |
| 8: | MonitorId mon=obtain_monitor(obj); |
| 9: | monitor_enter(mon); |
| 10: | while((obj−>lock & FAT_LOCK)= =0) { |

| | |
|---|---|
| 11: | set_flc_bit(obj); |
| 12: | |
| 13: | if (compare_and_swap(&obj−>lock, 0, thread_id())) |

| | |
|---|---|
| 14: | inflate(obj, mon); |

| | |
|---|---|
| 15: | else |

| | |
|---|---|
| 16: | monitor_wait(mon); |

| | |
|---|---|
| 17: | } |

| | |
|---|---|
| 18: | } |
| 19: | |
| 20: | void unlock(Object*obj){ |

| | |
|---|---|
| 21: | if ((obj−>lock & FAT_LOCK)= =0){/*light lock mode*/ |

| | |
|---|---|
| 22: | MEMORY_BARRIER(); |
| 23: | obj−>lock=0; |
| 24: | MEMORY_BARRIER(); |
| 25: | if (test_flc_bit(obj)){/*normally fails*/ |

| | |
|---|---|
| 26: | MonitorId mon=obtain_monitor(obj); |
| 27: | monitor_enter(mon); |
| 28: | if (test_flc_bit(obj)) |
| 29: | monitor_notify(mon); |
| 30: | monitor_exit(mon); |

| | |
|---|---|
| 31: | } |

| | |
|---|---|
| 32: | } |
| 33: | else {*/fat lock mode*/ |

| | |
|---|---|
| 34: | Word lockword=obj−>lock; |
| 35: | if (no thread waiting on obj) |

| | |
|---|---|
| 36: | if (better to deflate) |

| | |
|---|---|
| 37: | obj−>lock=0; /*shift to light lock mode*/ |

| | |
|---|---|
| 38: | monitor_exit(lockword & ˜FAT_LOCK); |

| | |
|---|---|
| 39: | } |

| | |
|---|---|
| 40: | } |
| 41: | |
| 42: | void inflate (Object*obj, MonitorId mon) { |

| | |
|---|---|
| 43: | clear_flc_bit(obj); |
| 44: | monitor_notify_all (mon); |
| 45: | obj−>lock=(Word) mon \| FAT_LOCK; |

| | |
|---|---|
| 46: | } |
| 47: | |
| 48: | |
| 49: | MonitorId obtain_monitor(Object*obj){ |

| | |
|---|---|
| 50: | Word word=obj−>lock; |
| 51: | MonitorId mon; |
| 52: | if (word & FAT_LOCK) |

| | |
|---|---|
| 53: | mon=word &˜FAT_LOCK; |

| | |
|---|---|
| 54: | else |

| | |
|---|---|
| 55: | mon=lookup_monitor(obj); |

| | |
|---|---|
| 56: | return mon; |

| | |
|---|---|
| 57: | } |

The features of the code in the above table are as follows. Here it should be noted that a contention bit (flc_bit) is newly introduced in order to prevent a reduction in the processing speed along the high frequency path.

(1) One field in an object header is employed for locking.

(2) There are two modes: a light lock mode and a fat lock mode, and the shape bit (FAT_LOCK) is provided to identify these two modes. The initial mode is the light lock mode.

(3) In the light mode, the following process is performed: The holder of a lock is stored in the lock field in the locked state, while a value of “0” is stored in the non-locked state, and a thread T, which acquires a lock by atomically writing its identifier in the lock field, releases the lock by simply (not atomically) clearing the lock field.

(4) In the fat lock mode, the following process is performed: The reference to a monitor structure is stored in the lock field, and the acquisition and release of a lock in the fat lock mode is realized as the entry of and exit from the monitor.

(5) When a contention occurs during the acquisition of a lock in the light lock mode, the mode is shifted to the fat lock mode (hereafter called the inflation of a lock), and at this time, allocation of the monitor structure is performed dynamically, as needed.

(6) When the object is unlocked in the fat lock mode, sometimes the mode is shifted to the light lock mode (hereinafter called the deflation of a lock).

The above features will now be described while referring to FIG. 7. As is shown in FIG. 7, when there is no thread locking a specific object (case (1)), a value of “0” is stored both in the lock field and in the contention bit, and when a specific thread acquires a lock on the object (a light lock), the identifier of the thread is stored in the lock field (case (2)). Meanwhile, if another thread does not attempt to acquire a lock until the object is unlocked by the thread represented by the thread identifier, the process is returned to case (1). But when another thread attempts to acquire a lock before the object is unlocked, a contention occurs in the light lock mode, and the contention bit is set to record this (case (3)). Then, when the light lock mode is shifted to the fat lock mode, the contention bit is cleared (case (4)). Thereafter, if possible, the process is shifted from case (4) to case (1). In FIG. 7, a bit (FAT_LOCK bit) that is used to indicate the light lock mode and the fat lock mode is provided at the least significant position of the lock field; however, this bit may be located at the most significant position.

The light lock mode process and the inflation process will now be described.

First, by the atomic command on the fourth line of the lock function, the acquisition is attempted of a lock in the light lock mode. If the current mode is the light lock mode and no contention occurs, the acquisition of the lock is successful. If not, the acquisition of a fat lock, i.e., the monitor, is entered, and the inflation process is initiated. At this time, if the current mode is already the fat lock mode, the body of the “while” statement is not executed. The obtain_monitor function is a function for returning a monitor that corresponds to an object. The association of the two is managed by using a hash table, for example.

On the other hand, in the unlock function, the shape bit is tested on the 21st line, and in the light lock mode the 22nd to 25th lines are executed. On the 23rd line, the unlocking function is performed, but any atomic command is not employed. The bit test performed on the 25th line, which will be described later, is related to the lock inflation process. When there is no contention, the bit test fails and the body of the “if” statement is not executed.

The processes unique to the SMP system are the memory synchronization commands on the 22nd and 24th lines. The memory synchronization command on the 22nd line, which is a requisite process for a compound lock, guarantees that the memory operation commands that are issued while the lock is maintained is completed before the object is unlocked. The memory synchronization command on the 24th line, which is unique to the Example compound lock 3, forces the release of the lock on the 23rd line, while the bit test on the 25th line is completed in the sequential order of the program.

The main feature of the inflation process of the compound lock is that in the inflation process monitor waiting but not busy waiting is employed. In addition, for unlocking the object in the light lock mode, this feature is implemented without using the atomic command and is an ideal locking method, at least for a uni-processor.

The biggest difficulty when monitor waiting is performed while busy waiting is halted is the provision of the notification guarantee, i.e., the guarantee that “a thread in the waiting state is always notified.” For the compound lock, one bit called an FLC (Flat Lock Contention) bit that is provided in a word other than a lock field is employed to constitute a clever protocol, so that the provisions of the notification guarantee are carried out. An explanation for this will now be given.

Assume that a thread T has entered into the waiting state on the 16th line. This means that the atomic command on the 13th line has failed, and this time is denoted by t. Assuming that the 10th to 13th line are written to guarantee the completion of the bit testing in the sequential program order, the FLC bit is set before time t.

The failure of the atomic command means that at the time t another thread S is holding the lock. This lock is a light lock for the following reasons. For the compound lock, the code is so written that the mode is always shifted under the protection provided by the monitor. The thread T has entered the monitor since it was entered on the 9th line, or has recovered from the waiting state on the 16th line. Further, the thread T has confirmed on the 10th line that the current mode is the light lock mode. Therefore, it is apparent that even on the 12th line the mode is still the light lock mode.

At the time t, the thread S holds the light lock. In particular, it does not execute the memory synchronization command on the 24th line. Therefore, the FLC bit is tested after the time t.

As a result, the thread T sets the FLC bit before the time t, and the thread S tests the FLC bit after the time t. Therefore, the thread S always succeeds in the testing on the 25th line, executing the body of the “if” statement, and notifies the thread T. That is, the notification guarantee is fulfilled.

If the memory synchronization command on the 24th line is not issued, the reading of a bit on the 25th line is probably executed before the writing on the 23rd line, and it can not be guaranteed that the testing of the FLC bit will be conducted after the time t, when the atomic command has failed. Thus, the issuing of the memory synchronization command on the 24th line is inevitable for establishing the correctness of the compound lock.

As is described above, when the compound lock is implemented by the SMP system, two memory synchronization commands are required to release a lock when a contention does not occur in the light lock mode.

To release the fat lock, the process is shifted to the 33rd line. On the 34th line, the contents of the lock field are stored in the variable “lockword.” Then, a check is performed to determine whether there is another thread that is in the waiting state (wait) of the monitor (35th line). If no thread is in the waiting state, a check is performed to determine whether a predetermined condition has been established (36th line). If there is such a condition that indicates the process should not exit from the fat lock mode, that condition is set as the predetermined condition. It should be noted that this step may not be performed. If the predetermined condition is established, a value of 0 is set for the lock field obj→lock (37th line). That is, the absence of a thread that holds a lock is stored in the lock field. Then, the process exits from the monitor whose identifier that is stored in a portion other than the shape bit in the lockword variable (38th line). The code “lockword & ˜FAT_LOCK” is the bitwise AND of the bitwise negation of FAT_LOCK and the “lockword”. Thus, a thread that is waiting to enter the monitor can now enter.

The “obtain_monitor” function for acquiring the monitor identifier will now be described. In this function, as well as in the above function, the contents of the lock field are stored in the “lockword” variable (50th line). Then, a variable “mon” is prepared to store the monitor identifier (51st line), and a check is performed to determine whether the FAT_LOCK bit has been set (52nd line, word & FAT_LOCK). If the FAT_LOCK bit has been set, the portion other than the FAT_LOCK bit in the lockword variable is stored in the variable mon (53rd line, lockword & ˜FAT_LOCK). If the FAT_LOCK bit has not been set, the “lookup_monitor(obj) function is executed (55th line). On the assumption that a hash table is provided in which the association of the object and the monitor is stored, the lookup_monitor(obj) function basically searches the table for the object obj, and acquires the monitor identifier. If needed, a monitor is created, and its monitor identifier is stored in the hash table and is thereafter returned to the mon variable. In either case, the stored monitor identifier is returned.

### SUMMARY OF THE INVENTION

It is one object of the present invention to provide an innovative compound lock method that does not reduce the processing speed attained along a frequent path.

To achieve the above object, according to the present invention, in the unlocking process when no contention occurs in the light lock mode, the number of memory synchronization commands is reduced to the minimum, i.e., by performing two-stage unlocking, preliminary unlocking and plenary unlocking, using a special identifier. Specifically, in a shared memory model system, a method whereby, in a state wherein a plurality of threads exist, a bit that represents a lock type and an identifier for a thread that has acquired a lock in accordance with a first lock type, or an identifier of a second lock type, are stored in a storage area that corresponds to an object and a lock on an object is thus managed, comprises the steps of: determining, if a second thread attempts to acquire a lock on a specific object that is held by a first thread, whether a bit that represents the lock type on the specific object represents the first lock type; setting a contention bit if the bit represents the first lock type; determining, before the first thread unlocks the specific object, whether the bit that represents the lock type represents the first lock type; storing in the storage area a special identifier that differs from the identifiers for the plurality of threads; issuing a synchronization command for the memory system; storing in the storage area data indicating the absence of a thread that holds the lock on the specific object; determining whether the contention bit has been set if the bit that represents the lock type represents the first lock type; and terminating an unlocking process if the contention bit has not been set without any other process being performed.

As a result, in the unlocking process when no contention appears in the light lock mode, in this invention two-stage unlocking is performed so that the expensive memory synchronization commands that are to be issued can be reduced from two to one.

The method for managing a lock on an object further comprises: shifting the first thread, when the contention bit has been set, to an exclusive control state for a mechanism that enables the exclusive control of the accessing of the object, and a thread waiting operation and the transmission to a waiting thread of a notification, both of which are to be performed when a predetermined condition has bee established; permitting the first thread to transmit the notification to the waiting thread; setting the second thread in the busy waiting state, when the predetermined condition has not been established and when the special identifier has been stored, until a thread that holds the lock on the specific object is no longer present and until the bit that represents the lock type represents the first lock type; and permitting the first thread to exit the exclusive control state.

As is described above, the method of the invention includes executing the transmission of a notification to a waiting thread, and a busy waiting process where, when the predetermined condition has not been established and when the special identifier has been stored, the lock process is held until a thread that holds the lock on the specific object is no longer present and until the bit that represents the lock type represents the first lock type.

The first lock type is a lock method whereby to manage a lock state an identifier for a thread that has locked an object is stored in correlation with the object. The second lock type is a lock method whereby a queue is employed to manage a thread that has locked to access the object.

In a shared memory model system, a method whereby, in a state wherein a plurality of threads exist, a bit that represents a lock is stored in a storage area that corresponds to an object, and a queue of a thread that accesses the object is stored to manage a lock on an object, comprises: determining, when a second thread attempts to acquire a lock on a specific object that a first thread has locked, whether a bit that is used to represent the lock on the object represents the locked state; changing data for the number of queues of threads that access the specific object and storing the updated data when the bit represents the locked state; storing the second thread in a queue, and shifting the second thread to a control state, for a mechanism that performs a waiting operation for accessing the specific object and a recovery operation by transmitting a notification; storing the bit that represents the locked state in the storage area before the first thread unlocks the object; determining whether a thread that is stored in a queue is present; shifting the first thread to a notification state, wherein the transmission of a notification to the thread that is waiting is initiated, when a thread that is stored in a queue is present; and permitting the first thread to exit the notification state.

As a result, an atomic locking or unlocking machine command (an indivisible command) is not required for a general spin suspended lock. That is, an atomic machine command is employed only for locking, and a simple-write command must only be employed for unlocking, instead of an atomic machine command.

The method for managing a lock on an object further comprises: increasing, when the bit that represents the locked state is set, the number of queues of threads that can access the specific object and storing the updated number, and determining whether the bit that represents the lock on the specific object represents the locked state; and reducing, when the bit that represents the locked state is not set, the number of the queues of the threads that access the specific object and storing the updated number, and terminating a locking process without any other process being performed.

In a shared memory model system, a method whereby, in a state wherein a plurality of threads exist, a bit that represents a lock is stored in a storage area that corresponds to an object, and a queue of threads that access the object is stored to manage a lock on an object, comprises: determining, when a second thread attempts to acquire a lock on a specific object that a first thread has locked, whether a bit that represents the lock on the object represents the locked state; changing, when the bit represents the locked state, data for the number of queues of threads that can access the specific object and storing the updated data, and thereafter issuing a synchronization command for the storage area; storing the second thread in a queue, and shifting the second thread to a control state for a mechanism that performs a waiting operation, for accessing the specific object, and a recovery operation by transmitting a notification; storing in the storage area, before the first thread unlocks the object, the bit that represents the locked state and an identifier that is not related to the representation of the locked state or an unlocked state; issuing a synchronization command for the storage area; storing, in the storage area, data that does not represent the lock on the specific object; determining whether a thread that is stored in a queue is present; shifting, when a thread that is stored in a queue is present, the first thread to a notification state wherein the transmission is initiated for issuing a notification to the thread that is waiting; and permitting the first thread to exit the notification state.

As a result, an atomic locking or unlocking machine command (an indivisible command) is not required for a general spin suspended lock. Furthermore, two memory synchronization commands are not required. That is, whereas conventionally a synchronization command is required before and after releasing the lock, according to the present invention, only one synchronization command is required to unlock an object at two stages.

The method for managing a lock on an object further comprises: increasing, when the bit that represents the locked state is set, the number of queues of threads that can access the specific object and storing the updated number, and determining whether the bit that represents the lock on the specific object represents the locked state; and reducing, when the bit that represents the locked state is not set, the number of the queues of the threads that access the specific object and storing the updated number, and terminating a locking process without any other process being performed.

In addition, the method for managing a lock on an object further comprises: permitting the second thread, when the bit that represents the locked state is set and when an identifier that is not related to the representation of the locked state or the unlocked state is stored in the storage area, to remain in a busy waiting state until a thread that maintains the lock on the object is no longer present and the bit that represents the locked state is changed to represent the unlocked state.

The above described processing for the invention can be carried out by a special apparatus or by a program loaded into a computer. Further, the program for the computer can be stored on a storage medium, such as a CD-ROM, a floppy disk or an MO (Magneto-Optical) disk, or in a storage device, such as a hard disk.

### BRIEF DESCRIPTION OF THE DRAWINGS

FIG. 1 is a diagram showing an example computer that performs the processing of the present invention.

FIG. 2 is a diagram for explaining the shifting of modes according to the present invention, and the states of a lock field (including a SHAPE bit) and a contention bit in each mode, with (1) showing the state where a lock has not been acquired, (2) showing a light lock mode where a contention has not occurred, (3) showing a light lock mode where a contention has occurred, (4) showing a fat lock mode, and (5) showing a preliminary unlocking using a special identifier.

FIG. 3 is a flowchart showing the locking process performed for a general compound lock according to the present invention.

FIG. 4 is a flowchart showing the unlocking process performed for the general compound lock according to the present invention.

FIG. 5 is a flowchart showing the locking process performed for an SMP compound lock according to the present invention.

FIG. 6 is a flowchart showing the unlocking process performed for the SMP compound lock according to the present invention.

FIG. 7 is a diagram for explaining the shifting of modes for an example compound lock 3, and the states of a lock field (including a FAT_LOCK bit) and a contention bit in each mode, with (1) showing the state where a lock has not been acquired, (2) showing a light lock mode where a contention has not occurred, (3) showing a light lock mode where a contention has occurred, and (4) showing a fat lock mode.

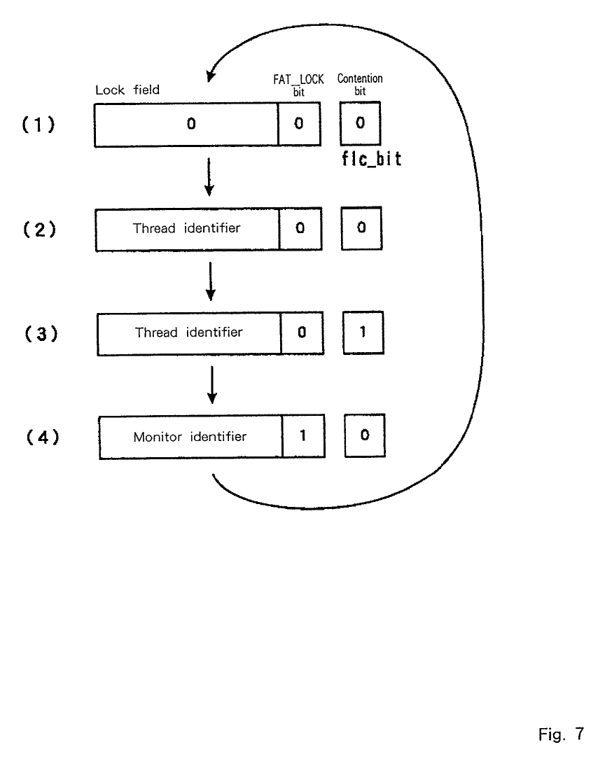

### [Description of the Symbols]

1000: Computer

100: Hardware

200: OS

200A: Kernel area

200B: User area

210: API

220: Thread library

300: Application program

310: Java VM

320: Java applet/application

330: Database management system

### BEST MODE FOR CARRYING OUT THE INVENTION

The preferred embodiments of the present invention will now be described while referring to the accompanying drawings. In these embodiments, the present invention is applied for an SMP system.

### First Embodiment

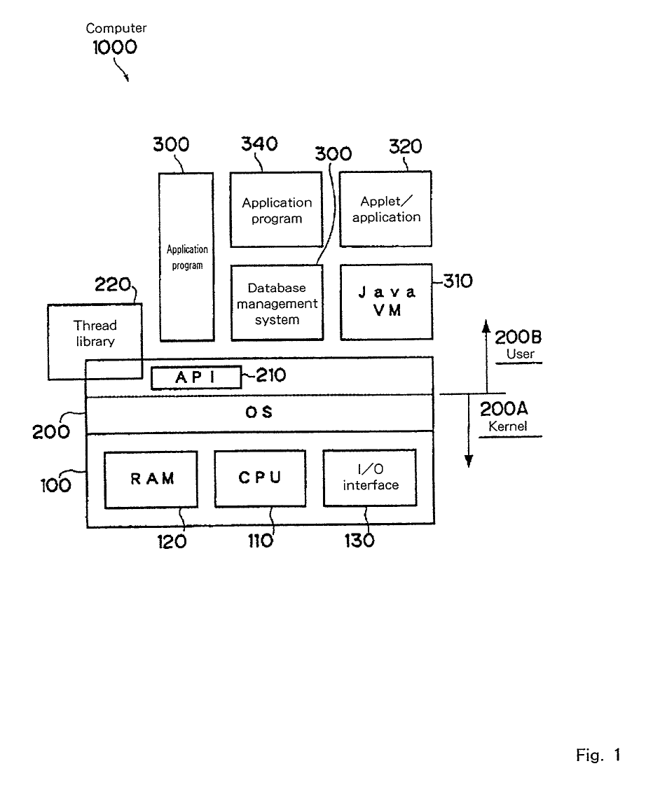

FIG. 1 is a diagram illustrating a computer that carries out the processing of this invention. A computer 1000 comprises hardware 100, an OS (Operating System) 200 and an application program 300. The hardware 100 includes a CPU (one or more) 110, a main memory, such as a RAM 120, and an input/output interface (I/O interface) 130 for accessing a hardware resource. The OS 200 is constituted by a kernel area 200A and a user area 200B, and includes an API (Application Programming Interface) 210. The OS 200 also includes a thread library 220 that has a function for enabling an operation performed between the hardware 100 and the application program 300, i.e., a function for enabling a plurality of threads to operate as the application programs 300. This thread library 220 provides a function for queue locking. The application program 300 includes a monitor function and a locking and unlocking function according to the invention. When a database language is employed, a database management system 330 may be provided above the OS 200, and an application 340 may be executed by the system 330. When the Java language is employed, a Java VM (Virtual Machine) 310 may be provided above the OS 220, and an applet or the application 320 may be executed by the Java VM 310. The execution of the applet or the application 320 can be performed by multi-threads. For the Java language, the monitor function and the locking and unlocking function may be installed in the Java VM 310. Further, the Java VM 310 may be implemented as a part of the OS 200. The computer 1000 may be a so-called network computer that does not have an auxiliary storage device.

(Reduction of Memory Synchronization Commands by Two-stage Unlocking)

As was described in the sub-division “SUMMARY OF THE INVENTION,” in example compound lock 3, when the locking method is implemented in the SMP system, two expensive memory synchronization commands must be issued to unlock an object when no contention occurs in the light lock mode. In this embodiment, an object is unlocked at two stages, preliminary unlocking and plenary unlocking, using a special identifier, so that only one memory synchronization command is required.

First, an identifier that is not assigned to any of the threads is selected, and the procedures for the unlocking function performed in the light lock mode are defined as the preliminary unlocking by using a special identifier, the issuing of the memory synchronization command, and the plenary unlocking. In this embodiment, “SPECIAL” is introduced as a special identifier for the preliminary unlocking.

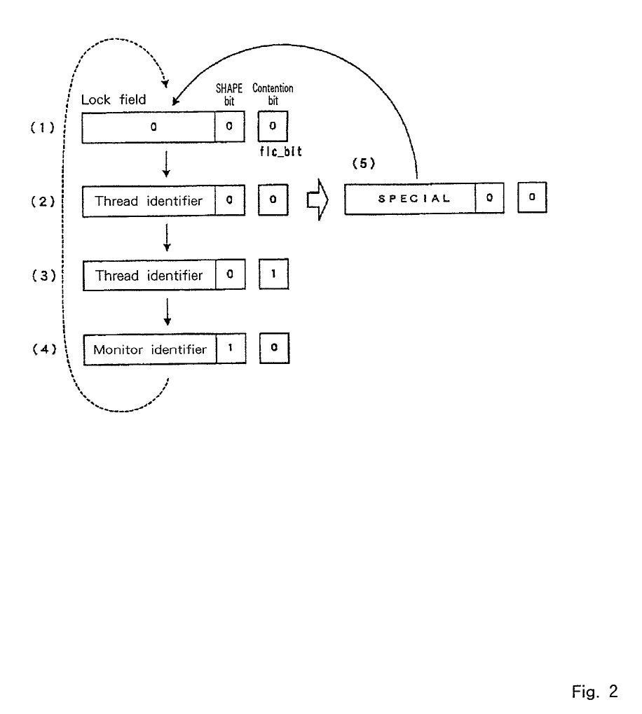

As is shown in FIG. 2, when there is no thread locking a specific object (case (1)), a value of 0 is stored in a lock field and a contention bit. Then, when a specific thread locks the object (light lock), the identifier for that thread is stored in the lock field (case (2)). If no other thread attempts to acquire a lock until the thread described by the pertinent thread identifier has unlocked the object, “SPECIAL” is stored in the lock field (case (5)), and the process is returned to case (1). When another thread attempts to acquire a lock before the specific thread has unlocked the object, a contention in the light lock mode has occurred, and a contention bit is set to record this contention (case (3)). Thereafter, the light lock mode is shifted to the fat lock mode, and the contention bit is cleared (case (4)). If possible, the process is shifted from case (4) to case (1). In this example, a bit (FAT_LOCK bit) that represents the light lock mode and the fat lock mode is provided at the least significant position in the lock field; however this bit may be provided at the most significant position.

The processing wherein “SPECIAL” is introduced as the special identifier will now be described.

TABLE 5

| | |
|---|---|
| 10: | void unlock(Object*obj){ |

| | |
|---|---|
| 20: | if ((obj−>lock & SHAPE_BIT)= =0){/*light lock mode*/ |

| | |
|---|---|
| 30: | obj−>lock=SPECIAL; |
| 40: | MEMORY_BARRIER(); |
| 50: | obj−>lock=0; |
| 60: | if (test_flc_bit(obj)){/*normally fails*/ |

| | |
|---|---|
| 70: | MonitorId mon=obtain_monitor(obj); |
| 80: | monitor_enter(mon); |
| 90: | if (test_flc_bit(obj)) |

| | |
|---|---|
| 100: | monitor_notify(mon); |

| | |
|---|---|
| 110: | monitor_exit(mon); |

| | |
|---|---|
| 120: | } |

| | |
|---|---|
| 130: | } |
| 140: | else {/*fat lock mode*/ |

| | |
|---|---|
| 150: | Word lockword=obj−>lock; |
| 160: | if (no thread waiting on obj) |

| | |
|---|---|
| 170: | if (better to deflate) |

| | |
|---|---|
| 180: | obj−>lock=0; /*shift to light lock mode*/ |

| | |
|---|---|
| 190: | monitor_exit(lockword & ˜FAT_LOCK); |

| | |
|---|---|
| 200: | } |

| | |
|---|---|
| 210: | } |
| 220: | |
| 230: | void lock(Object*obj){ |

| | |
|---|---|
| 240: | /*acquire lock in light lock mode*/ |
| 250: | int unlocked=0; |
| 260: | if(compare_and_swap370(&obj−>lock,&unlocked, |

thread_id()))

| | |
|---|---|
| 270: | return;/*success*/ |
| 280: | |

| | |
|---|---|
| 290: | /*failure: enter monitor, shift to fat lock mode*/ |
| 300: | MonitorId mon=obtain_monitor(obj); |
| 310: | monitor_enter(mon); |
| 320: | while ((obj−>lock & SHAPE_BIT)==0){ |

| | |
|---|---|
| 330: | set_flc_bit(obj); |
| 340: | unlocked=0; |

| | |
|---|---|
| 350: | if(compare_and_swap_370(&obj−>lock, |

&unlocked, thread_id()))

| | |
|---|---|
| 360: | inflate (obj,mon); |

| | |
|---|---|
| 370: | else if (unlocked= =SPECIAL) |

| | |
|---|---|
| 380: | ;/*busy waiting*/ |

| | |
|---|---|
| 390: | else |

| | |
|---|---|
| 400: | monitor_wait(mon); |

| | |
|---|---|
| 410: | } |

| | |
|---|---|
| 420: | } |
| 430: | |
| 440: | void inflate (Object*obj, MonitorId mon){ |

| | |
|---|---|
| 450: | clear_flc_bit(obj); |
| 460: | monitor_notify_all (mon); |
| 470: | obj−>lock=(Word) mon\|SHAPE; |

| | |
|---|---|
| 480: | } |
| 490: | |
| 500: | |
| 510: | MonitorId obtain_monitor(Object*o){ |

| | |
|---|---|
| 520: | Word lockword=obj−>lock; |
| 530: | MonitorID mon; |
| 540: | if (lockword & SHAPE) |

| | |
|---|---|
| 550: | mon = lockword & ˜SHAPE; |

| | |
|---|---|
| 560: | else |

| | |
|---|---|
| 570: | mon = lookup_monitor(o); |

| | |
|---|---|
| 580: | return mon; |

| | |
|---|---|
| 590: | } |

In the above program, the original compare_and_swap_{—}370 that is defined in IBM System/370 is employed. The function “compare_and_swap_{—}370()” atomically performs the following processing.

TABLE 6

| | |
|---|---|
| 100: | int compare_and_swap_370(Word*word,Word*old,Word |

new){

| | |
|---|---|
| 110: | if(*word= =*old){ |

| | |
|---|---|
| 120: | *word=new; return 1; /*succeed*/ |

| | |
|---|---|
| 130: | }else{ |
| 140: | *old=*word; return 0;/*fail*/ |
| 150: | } |

| | |
|---|---|
| 160: | } |

The contention bit is represented as flc_bit in Table 4. Table 5 above consists of four portions: the lock function (the 220th through the 420th lines), the unlock function (the 10th through the 210th lines), the inflate function for shifting the light lock mode to the fat lock mode (the 440th through the 480th lines), and the obtain_monitor function for acquiring the identifier for a monitor (the 510th through the 590th lines). The processing for Table 5 will now be described in detail. In Table 5, the contention bit is represented as SHAPE bit instead of the FAT_LOCK bit in Table 4.

### (1) Lock Function

In the process for the lock function that is initiated on the 230th line for an object obj, first the acquisition of a light lock is attempted (250th and 260th lines). In this embodiment, an atomic command, such as compare_and_swap is employed to acquire the light lock. This command instructs the storage of the third argument when the first and the second arguments are equal. In this embodiment, when a value in the lock field “obj→lock” of the object obj is equal to 0, a thread identifier is obtained from thread_id(), and is stored in the lock field obj→lock. This is the shift from case (1) to case (2) in FIG. 2. Program control is returned in order to perform a necessary process (270th line). If the value in the lock field obj→lock of the object obj is not equal to 0, the acquisition of the light lock fails and program control shifts to the 300th line.

Then, the value of the obtain_monitor(obj) function that acquires a monitor identifier is loaded into the variable “mon” (300th line), and a thread attempts to shift to the exclusive control state of the monitor. That is, the thread attempts to enter the monitor (310th line). If the thread can shift to the exclusive control state, the following process is performed. If the thread can not shift to the exclusive control state, it waits here until the shift is enabled. Next, the condition of the “while” statement is examined. Specifically, the value in the lock field obj→lock and the SHAPE bit are bitwise-ANDed to determine whether the SHAPE bit is set (320th line). In this case, whether currently the lock mode is shifted to the fat lock mode or is still in the light lock mode. If the SHAPE bit is not set (in the light lock mode), the obtained calculation results are 0, and the process of the body of the “while” statement is begun. If the SHAPE bit is set (in the fat lock mode), the process of the body of the “while” statement is not performed, and the thread remains in the monitor. As is described above, when the SHAPE bit has been set and when the thread has successfully entered the monitor, it means that the fat lock can be acquired. Without exiting the monitor (i.e., without exiting the exclusive control state), the thread can perform the process for the pertinent object.

When it is ascertained at line 320 that the SHAPE bit has not been set, it is assumed that a light lock contention has occurred and the flc_bit is set (330th line, set_flc_bit(obj)). This process corresponds to the shift from case (2) to (3) in FIG. 2, and a check is again performed to determine whether a light lock can be acquired (340th and 350th lines). When the light lock can be acquired, the inflate function process is performed to shift from the light lock mode to the fat lock mode (360th line). When the light lock can not be obtained and the “unlock” variable is SPECIAL, the thread enters the busy waiting state. In other words, in this embodiment, the busy wait is re-introduced because busy-waiting is preferable at this time in the SMP system. This state is entered when the plenary unlocking is not observed yet the preliminary unlocking is, and when the plenary unlocking is about to be performed. When the light lock can not be acquired and the “unlock” variable is not SPECIAL, the thread is shifted to the monitor waiting state (400th line). In the monitor waiting state, the thread exits the monitor and is suspended, and when a contention occurs in the light lock mode, the contention bit flc_bit is set, whereas when the light lock can not be obtained, the thread is shifted to the monitor waiting state. In this waiting state, a notification (notify or notify_all) is thereafter received in the inflate function or in the unlocking process.

### (2) Inflate Function

Now, the inflate function will be described. First, the contention bit is cleared (450th line, clear_flc_bit), and the monitor notification operation (monitor_notify_all) is performed (460th line). In this case, all the threads that are waiting receive a notification to wake up. The variable mon in which the monitor identifier is stored and the SHAPE bit that is set are bitwise-ORed, and the obtained results are stored in the lock field obj→lock (440th, mon|SHAPE). That is, the process corresponds to case (3) to case (4) in FIG. 2. The shifting from the light lock mode to the fat lock mode is thus completed. It should be noted that when the process on line 360 is completed, the condition for the “while” statement is examined again. In this case, however, since the SHAPE bit has already been set, the thread exits from the “while” statement and remains in the monitor.

Upon receipt of the notification, all the threads implicitly attempt to enter the monitor at line 400, but must wait before they can enter. This is because the thread that has transmitted the notification does not exit the monitor until it initiates the unlocking process.

### (3) Unlock Function

The unlock function will now be described. The unlock function handles both the release of a light lock and the release of a fat lock.

Releasing a Light Lock

To release a light lock, first the value in the lock field obj→lock and the SHAPE bit are bitwise-ANDed, and a check is performed to determine whether the obtained value is 0 (200th line). This process is performed to determine whether the current mode is the light lock mode; the same condition as the “while” statement of the lock function is employed (320th line). If the mode is the light lock mode, the preliminary unlocking is performed by using a special identifier (30th line: obj→lock=SPECIAL). This process corresponds to the shift from case (2) to case (5) in FIG. 2. When a memory synchronization command is executed (40th line: MEMORY_BARRIER()), a value of 0 is stored in the lock field obj→lock to perform plenary unlocking (50th line). This process corresponds to the shift from case (5) to case (1) in FIG. 2.

In this manner, since the unlocking is performed at two stages when no contention occurs in the light lock mode, the two expensive memory synchronization commands that are conventionally required can be reduced to only one command. That is, the memory synchronization command for this invention is only on the 40th line. In this manner, the procedures for the unlock function in the light lock mode are set in the order: the preliminary unlocking using a special identifier, the issuing of the memory synchronization command, and the plenary unlocking. Thus, the absence of a thread that holds a lock is recorded. Then, a check is performed to determine whether a contention bit has been set (60th line, test_flc_bit). Even when a contention has not occurred in the light lock mode, the process on the 60th line must be performed. When the contention bit is not set, the unlocking process is terminated.

When the contention bit is set, the monitor identifier is stored in the variable mon as on the 300th and 310th lines of the lock function (70th line), and the thread enters the monitor having the pertinent monitor identifier (80th line). If the thread succeeds in entering the monitor exclusive control state, the thread again confirms the contention bit is set (90th line). If the thread confirms the contention bit, it notifies one of the waiting threads in the monitor (100th line, monitor_notify(mon)). If the thread can not enter the monitor, it waits until it can. The thread that issued the notification then exits the monitor exclusive control state (110th line, monitor_ext(mon)).

Upon receipt of the notification on the 100th line, the thread implicitly enters the monitor on the 400th line. The program returns to the 90th line, and the process is performed. Normally, the thread that receives the notification on the 100th line enters the monitor exclusive control state after the thread has exited the monitor exclusive control state. The light lock is obtained after the contention bit has been set, and the inflate function is performed to shift the light lock mode to the fat lock mode.

In this embodiment, only one memory synchronization command is employed, and the notification guarantee is achieved by developing a theory substantially the same as that for example compound lock 3 above. Specifically, assume that the thread T has entered the monitor waiting state, and the time whereat the thread T failed in the atomic command is defined as t and the FLC bit was set before time t. It should be noted that the value in the lock field at the time t is not SPECIAL.

When another thread S holds the light lock at the time t, the value in the lock field at the time t is not SPECIAL, and the thread S does not execute the memory synchronization command at the time t. That is, the testing of the FLC bit is performed after the time t; this is done even when the plenary unlocking and testing of the FLC bit are performed in the reverse order. As a result, the notification guarantee is achieved.

In this embodiment, the busy waiting is re-introduced, and is extremely limited. Further, the busy waiting is rather effective for the SMP system. In this embodiment, the thread enters the busy waiting state when the preliminary unlocking but not the plenary unlocking is observed. Thus, the unlocking is about to be performed. At this time, it is effective for the SMP system to busy-wait rather than to enter the monitor waiting state and to switch the context.

### Second Embodiment

The present invention can effectively perform the general spin suspend lock (a compound lock, consisting of a spin lock and a queue lock). Specifically, the present invention can be represented by the following general spin suspend lock, which in the following explanation is called a general compound lock. The spin suspend lock is widely employed, and is also used for implementing the “critical section” of OS/2 and the mutex variable of the “pthreads” library of the AIX. However, for the performance at the time there is no contention, while a conventional algorithm requires one atomic command to acquire and one to release a lock, the general compound lock of this embodiment requires an atomic command only for the acquisition of a lock. Further, the same reference numerals as are used in the above embodiment are employed in this embodiment to denote corresponding components, and for this no detailed explanation will be given.

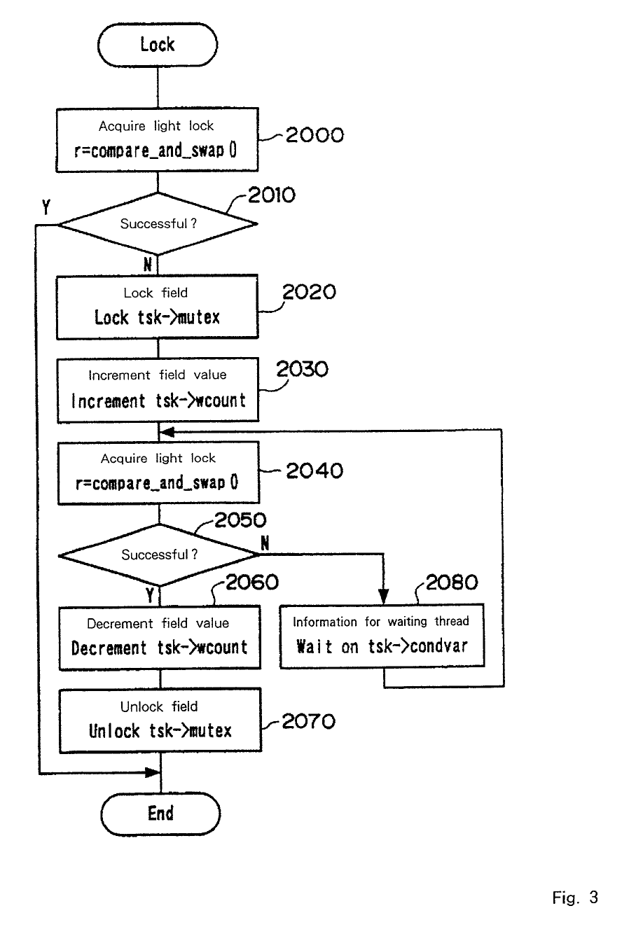

First, the locking process performed for this embodiment will be described. As is shown in FIG. 3, at step 2000 acquisition of a light lock is attempted by using an atomic command, and at step 2010 a check is performed to determine whether the acquisition of a light lock was successful. When the lock acquisition was successful, this routine is terminated. But when the lock acquisition failed, it is assumed that another thread has already acquired a lock, the lock mode is shifted to the suspend mode, and at step 2020, a field employing the mutex variable that has the same semantics as are provided by the “pthreads” library is locked. At step 2030, the value of a field that represents the number of waiting threads is incremented. That is, it is announced that the current thread is to be added. And at step 2040, the acquisition of a light lock is again attempted. When the lock acquisition is successful, at step 2060 the value of the field is decremented, and at step 2070 the field using the mutex variable is unlocked. But when the lock acquisition fails, at step 2080 the thread that attempted the lock acquisition waits, in a queue, and program control thereafter returns to step 2040.

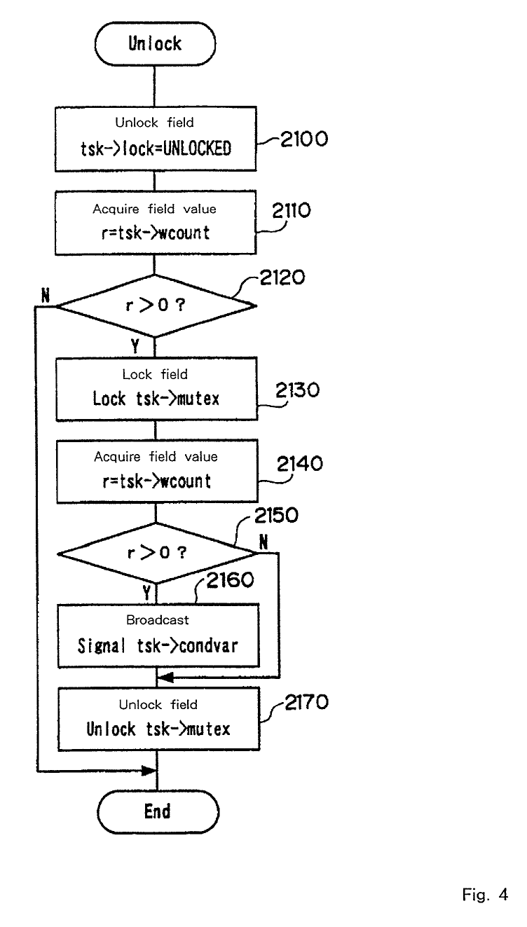

The unlocking process will now be described. As is shown in FIG. 4, at step 2100 a field for a lock is released, and at step 2110 the value of the field that represents the number of waiting threads is acquired. Since when there are no waiting threads the value of the field is “0”, this routine is terminated. But when there is a thread waiting, the decision at step 2120 is affirmative, and at step 2130 the field using the mutex variable is locked. At step 2140 the number of the field that represents the number of waiting threads is again acquired, and at step 2150 another check is performed to determine whether there is a waiting thread. If there are no waiting threads, at step 2170 the field using the mutex variable is unlocked and this routine is terminated. When there is a waiting thread, at step 2160 the waiting thread is read (reported), and at step 2170 the field using the mutex variable is unlocked. This routine is thereafter terminated.

The following is the algorithm for the general compound lock used for the above processing.

TABLE 7

| | |
|---|---|
| 10: | typedef struct { |

| | |
|---|---|
| 20: | int lock; /*initially, UNLOCKED*/ |
| 30: | int wcount; /*initially, 0*/ |
| 40: | mutex_t mutex; |
| 50: | condvar_t condvar; |

| | |
|---|---|
| 60: | }tsk_t; |
| 70: | |
| 80: | void tsk_lock(tsk_t *tsk){ |

| | |
|---|---|
| 90: | if (compare_and_swap(&tsk−>lock; |

UNLOCKED,LOCKED))

| | |
|---|---|
| 100: | return; /*ok*/ |

| | |
|---|---|
| 110: | tsk_suspend(tsk); |

| | |
|---|---|
| 120: | } |
| 130: | |
| 140: | void tsk_unlock(tsk_t *tsk){ |

| | |
|---|---|
| 150: | tsk−>lock=UNLOCKED; |
| 160: | if(tsk−>wcount) |

| | |
|---|---|
| 170: | tsk_resume(tsk); |

| | |
|---|---|
| 180: | } |
| 190: | |
| 200: | void tsk_suspend(tsk_t *tsk){ |

| | |
|---|---|
| 210: | mutex_lock(&tsk−>mutex); |
| 220: | tsk−>wcount+ +; |
| 230: | while(1){ |

| | |
|---|---|
| 240: | if (compare_and_swap(&tsk−>lock; |

UNLOCKED,LOCKED)){

| | |
|---|---|
| 250: | tsk−>wcount--; |
| 260: | break; |

| | |
|---|---|
| 270: | } |
| 280: | else |

| | |
|---|---|
| 290: | condvar_wait(&tsk−>condvar, &tsk−>mutex); |

| | |
|---|---|
| 300: | } |
| 310: | mutex_unlock(&tsk−>mutex); |

| | |
|---|---|
| 320: | } |
| 330: | |
| 340: | void tsk_resume(tasuki_t *tsk){ |

| | |
|---|---|
| 350: | mutex_lock(&tsk−>mutex); |
| 360: | if(tsk−>wcount) |

| | |
|---|---|
| 370: | condvar_signal(&tsk−>condvar); |

| | |
|---|---|
| 380: | mutex_unlock(&tsk−>mutex); |

| | |
|---|---|
| 390: | } |

According to this algorithm, the tsk_suspend function and the tsk_resume function are written by using the mutex variable and the condvar variable that have the same semantics as those provided by the pthreads library, and this is basically because of the explanation provided for the algorithm. The general compound lock will not be prepared in the thread library, and should instead be prepared in a more customized form in the kernel space.

The condvar_wait() function, which is a conditional variable, waits by using the first argument as a variable and unlocks the mutex variable. In accordance with this function, a notification is transmitted by the condvar_signal() function.

In Table 7, the 10th through the 60th lines represent the structure of the data to be employed, the 80th through the 120th lines represent the lock function, the 140th through the 180th lines represent the unlock function, the 200th through the 320th lines represent the suspend function, and the 340th through the 390th lines represent the resume function.

As is apparent from Table 7, the lock function includes simple spin locking. The unlock function currently includes the testing of the field tsk→wcount. This indicates whether a thread that holds a lock needs to perform a specific unlocking operation for another thread that is retracted into the suspend lock. However, unless the condition of the if statement on the 160th line is established, the tsk_resume function is not executed. This tsk_resume function conducts a simple test, and does not perform an important process. Therefore, compared with the algorithm that performs the fastest spin lock, only one simple test is added to the algorithm in Table 7.

The tsk_suspend function includes a “while loop” in which a thread that is called obtains a spin lock. This loop is not a “spin-wait” loop, but a “suspend-wait” loop. That is, it must be assured that all of the threads waiting on the 290th line are released from the waiting state. Therefore, information is continuously obtained concerning the number of threads that are currently waiting in the field tsk→wcount, and the counter value (tsk_wcount) is incremented and decremented under the protection of the mutex. Thus, when the counter value is examined under the same protection, the precise number of waiting threads can be obtained.

Sometimes, the unlock function examines the value of a counter that is not under any protection, and reads an incorrect value; however, in this embodiment, in accordance with the above described assumption, notification of the release of a thread from the waiting state is ensured.

### Specific Application for SMP System

When the general compound lock is to be implemented in an SMP system, i.e., an advanced SMP system, the same problem is encountered as is encountered for the example compound lock 3. That is, when the lock is released at the time there is no contention, two memory synchronization commands must be issued; specifically, before and after the 150th line in Table 7: “tsk→lock=UNLOCKED;.” This problem can be resolved by performing the same process as is performed in the above embodiment. The general compound lock that is applied for the SMP system is called an SMP compound lock in this embodiment.

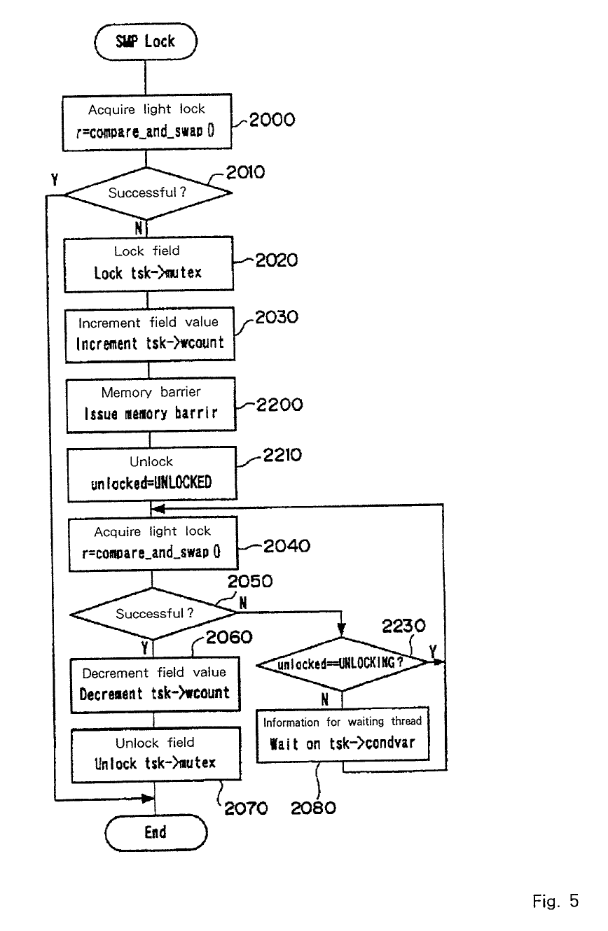

First, the locking process will be described. As is shown in FIG. 5, acquisition of a light lock is attempted by using the atomic command (step 2000 in FIG. 3), and a check is performed to determine whether the acquisition of a light lock was successful (step 2010 in FIG. 3). When the lock acquisition was successful, this routine is terminated. But when the lock acquisition fails, it is assumed that another thread has already acquired a lock, the lock mode is shifted to the suspend mode, and a field employing the mutex variable that has the same semantics as those provided by the “pthreads” library is locked (step 2020 in FIG. 3). The value of a field that represents the number of waiting threads is then incremented (step 2030 in FIG. 3). That is, it is announced that the current thread is to be added. At step 2200, the memory barrier (MEMORY_BARRIER()) is issued, and at step 2210 the variable “unlocked” is released. The memory synchronization command guarantees that the memory operation commands issued while the lock is held is completed before the lock is released.

The acquisition of a light lock is attempted again (step 2040 in FIG. 3). When the lock acquisition was successful, the value of the field is decremented (step 2060 in FIG. 3), and the field using the mutex variable is unlocked (step 2070 in FIG. 3). But when the lock acquisition failed, at step 2230 a check is performed to determine whether the UNLOCKING value is filled. When the decision is affirmative, program control returns to step 2040. However, when the decision at step 2230 is negative, the thread that attempted to acquire the lock is added to a queue to wait (step 2080 in FIG. 3), and program control thereafter returns to step 2040.

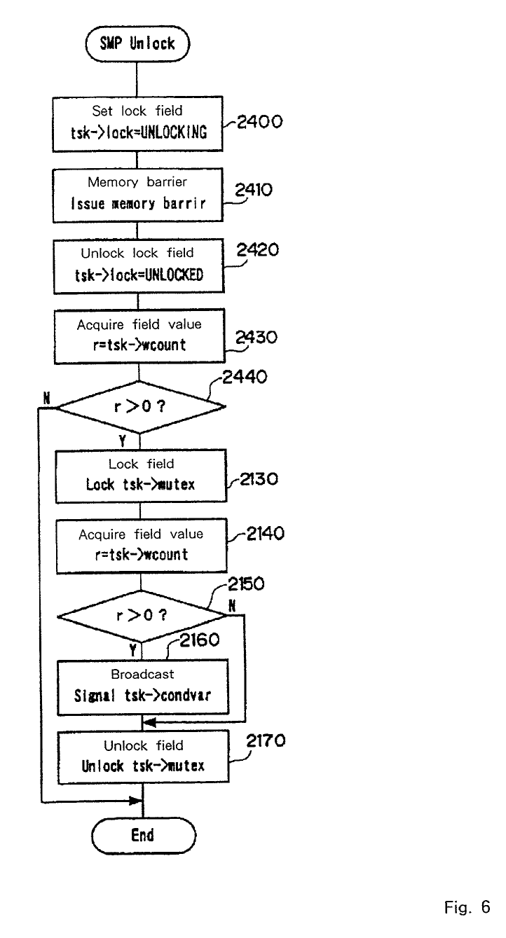

Unlocking process will now be described. As is shown in FIG. 6, at step 2400 a value indicating a preliminary unlocking is substituted into the lock field, and at step 2410 the memory synchronization command is issued. Then, at step 2420 the lock field is released, and at step 2430 the value of a field that represents the number of waiting threads is acquired. Since the value of the field is “0” when there are no waiting threads, this routine is terminated. When there is a waiting thread, as in the process following step 2130 in FIG. 4, the field using the mutex variable is locked. Then, the value of the field that represents the number of waiting threads is again acquired, and a check is again performed to determine whether there are any waiting threads. If there are no waiting threads, the field using the mutex variable is unlocked. But when there is a waiting thread, the waiting thread is read (reported), and the field using the mutex variable is unlocked. This routine is thereafter terminated.

The following is the algorithm for the SMP compound lock for the above processing. This algorithm employs the original compare_and_swap_{—}370 that is defined by the IBM SyStem/370, and when the compare_and_swap_{—}370 function is employed, the tsk_unlock function and the tsk_suspend function are as follows, while the other two functions are unchanged.

TABLE 8

| | |
|---|---|
| 500: | void tsk_unlock_smp(tsk_t *tsk){ |

| | |
|---|---|
| 510: | tsk−>lock=UNLOCKING; |
| 520: | MEMORY_BARRIER(); |
| 530: | tsk−>lock=UNLOCKED |
| 540: | |
| 550: | if(tsk−>wcount) |

| | |
|---|---|
| 560: | tsk_resume(tsk); |

| | |
|---|---|
| 570: | } |
| 580: | |
| 590: | void tsk_suspend_smp(tsk_t *tsk){ |

| | |
|---|---|
| 600: | mutex_lock(&tsk−>mutex); |
| 610: | tsk−>wcount+ +; |
| 620: | MEMORY_BARRIER(); |
| 630: | while(1){ |

| | |
|---|---|
| 640: | int unlocked=UNLOCKED; |
| 650: | if(compare_and_swap_370(&tsk−>lock; UNLOCKED, |

LOCKED)){

| | |
|---|---|
| 660: | tsk−>wcount--; |
| 670: | break; |

| | |
|---|---|
| 680: | }else if(unlocked= =UNLOCKING){ |

| | |
|---|---|
| 690: | ;/*spin-wait*/ |

| | |
|---|---|
| 700: | }else |

| | |
|---|---|
| 710: | condvar_wait(&tsk−>condvar, &tsk−>mutex); |

| | |
|---|---|
| 720: | } |
| 730: | mutex_unlock(&tsk−>mutex); |

| | |
|---|---|
| 740: | } |

As is described above, according to this embodiment one of the identifiers that are not assigned is selected, and the procedures for the unlock function in the light lock mode are defined as the preliminary unlock using the special identifier, the memory synchronization command and plenary unlock. In this embodiment, “UNLOCKING” is employed as the special identifier for the preliminary unlock. That is, in the unlock function, the value of the field tsk→lock is temporarily set to UNLOCKING other than UNLOCKED, the memory barrier is performed. Therefore, the processing using only one memory synchronization command can be performed by the two-stage unlock, the preliminary unlock using the special identifier and plenary unlocking.

As is described above, according to the present invention, in the unlocking process when no contention occurs in the light lock mode, the number of required memory synchronization commands can be minimized by performing two-stage unlocking, the preliminary unlocking using a special identifier, and the plenary unlocking.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What we claim is:

1. In a shared memory model system, a method whereby, in a state wherein a plurality of threads exist, a bit that represents a lock type and an identifier for a thread that has acquired a lock in accordance with a first lock type, or an identifier of a second lock type, are stored in a storage area that corresponds to an object and a lock on an object is thus managed, said method comprising:
determining, if a second thread attempts to acquire a lock on a specific object that is held by a first thread, whether a bit that represents said lock type on said specific object represents said first lock type;
setting a contention bit if said bit represents said first lock type;
determining, before said first thread unlocks said specific object, whether said bit that represents said lock type represents said first lock type;
storing in said storage area a special identifier that differs from the identifiers for said plurality of threads;
issuing a synchronization command for said memory system;
storing in said storage area data indicating the absence of a thread that holds said lock on said specific object;
determining whether said contention bit has been set if said bit that represents said lock type represents said first lock type; and
terminating an unlocking process if said contention bit has not been set without any other process being performed.

2. The lock management method according to claim 1, further comprising:
shifting said first thread, when said contention bit has been set, to an exclusive control state for a mechanism that enables the exclusive control of the accessing of said object, and a thread waiting operation and the transmission to a waiting thread of a notification, both of which are to be performed when a predetermined condition has been established;
permitting said first thread to transmit said notification to said waiting thread;
setting said second thread in the busy waiting state, when said predetermined condition has not been established and when said special identifier has been stored, until a thread that holds said lock on said specific object is no longer present and until said bit that represents said lock type represents said first lock type; and
permitting said first thread to exit said exclusive control state.

3. The lock management method according to claim 1, wherein said first lock type is a lock method whereby to manage a lock state an identifier for a thread that has locked an object is stored in correlation with said object.

4. The lock management method according to claim 1, wherein said second lock type is a lock method whereby a queue is employed to manage a thread that has locked an access to an object.

5. In a shared memory model system, an apparatus where, in a state wherein a plurality of threads exist, a bit that represents a lock type and an identifier for a thread that has acquired a lock in accordance with a first lock type, or an identifier of a second lock type, are stored in a storage area that corresponds to an object and a lock on an object is thus managed, said apparatus comprising:
means for determining, if a second thread attempts to acquire a lock on a specific object that is held by a first thread, whether a bit that represents said lock type on said specific object represents said first lock type;
means for setting a contention bit if said bit represents said first lock type;
means for determining, before said first thread unlocks said specific object, whether said bit that represents said lock type represents said first lock type;
means for storing in said storage area a special identifier that differs from the identifiers for said plurality of threads;
means for issuing a synchronization command for said storage area;
means for storing in said storage area data indicating the absence of a thread that maintains said lock on said specific object;
means for determining whether said contention bit has been set if said bit that represents said lock type represents said first lock type; and
means for terminating an unlocking process if said contention bit has not been set without any other process being performed.

6. The lock management apparatus according to claim 5, further comprising:
means for shifting said first thread, when said contention bit has been set, to an exclusive control state for a mechanism that enables the exclusive control of the accessing of said object, and a thread waiting operation and the transmission to a waiting thread of a notification, both of which are to be performed when a predetermined condition has bee established;
means for permitting said first thread to transmit said notification to said waiting thread;
means for setting said second thread in the busy waiting state, when said predetermined condition has not been established and when said special identifier has been stored, until a thread that maintains said lock on said specific object is no longer present and until said bit that represents said lock type represents said first lock type; and
means for permitting said first thread to exit said exclusive control state.

7. The lock management apparatus according to claim 5, wherein said first lock type is a lock method whereby to manage a lock state an identifier for a thread that has locked an object is stored in correlation with said object.

8. The lock management apparatus according to claim 5, wherein said second lock type is a lock method whereby a queue is employed to manage a thread that has locked an access to an object.

9. In a shared memory model system, a method whereby, in a state wherein a plurality of threads exist, a bit that represents a lock is stored in a storage area that corresponds to an object, and a queue of a thread that accesses said object is stored to manage a lock on an object, said method comprising:
determining, when a second thread attempts to acquire a lock on a specific object that a first thread has locked, whether a bit that is used to represent said lock on said object represents the locked state;
changing data for the number of queues of threads that access said specific object and storing the updated data when said bit represents said locked state;
storing said second thread in a queue, and shifting said second thread to a control state, for a mechanism that performs a waiting operation for accessing said specific object and a recovery operation by transmitting a notification;
storing said bit that represents said locked state in said storage area before said first thread unlocks said object;
determining whether a thread that is stored in a queue is present;
shifting said first thread to a notification state, wherein said transmission of a notification to said thread that is waiting is initiated, when a thread that is stored in a queue is present; and
permitting said first thread to exit said notification state.

10. The lock management method according to claim 9, further comprising:
increasing, when said bit that represents said locked state is set, the number of queues of threads that can access said specific object and storing the updated number, and determining whether said bit that represents said lock on said specific object represents said locked state; and
reducing, when said bit that represents said locked state is not set, the number of said queues of said threads that access said specific object and storing the updated number, and terminating a locking process without any other process being performed.

11. In a shared memory model system, a method whereby, in a state wherein a plurality of threads exist, a bit that represents a lock is stored in a storage area that corresponds to an object, and a queue of threads that access said object is stored to manage a lock on an object, said method comprising:
determining, when a second thread attempts to acquire a lock on a specific object that a first thread has locked, whether a bit that represents said lock on said object represents the locked state;
changing, when said bit represents said locked state, data for the number of queues of threads that can access said specific object and storing the updated data, and thereafter issuing a synchronization command for said storage area;
storing said second thread in a queue, and shifting said second thread to a control state for a mechanism that performs a waiting operation, for accessing said specific object, and a recovery operation by transmitting a notification;
storing in said storage area, before said first thread unlocks said object, said bit that represents said locked state and an identifier that is not related to the representation of said locked state or an unlocked state;
issuing a synchronization command for said storage area;
storing, in said storage area, data that does not represent said lock on said specific object;
determining whether a thread that is stored in a queue is present;
shifting, when a thread that is stored in a queue is present, said first thread to a notification state wherein said transmission is initiated for issuing a notification to said thread that is waiting; and
permitting said first thread to exit said notification state.

12. The lock management method according to claim 11, further comprising:
increasing, when said bit that represents said locked state is set, the number of queues of threads that can access said specific object and storing the updated number, and determining whether said bit that represents said lock on said specific object represents said locked state; and
reducing, when said bit that represents said locked state is not set, the number of said queues of said threads that access said specific object and storing the updated number, and terminating a locking process without any other process being performed.

13. The lock management method according to claim 12, further comprising:
permitting said second thread, when said bit that represents said locked state is set and when an identifier that is not related to the representation of said locked state or said unlocked state is stored in said storage area, to remain in a busy waiting state until a thread that maintains said lock on said object is no longer present and said bit that represents said locked state is changed to represent said unlocked state.

14. In a shared memory model system, an apparatus where, in a state wherein a plurality of threads exist, a bit that represents a lock is stored in a storage area that corresponds to an object, and a queue of a thread that accesses said object is stored to manage a lock on an object, said apparatus comprising:
means for determining, when a second thread attempts to acquire a lock on a specific object that a first thread has locked, whether a bit that is used to represent said lock on said object represents the locked state;
means for changing data for the number of queues of threads that access said specific object and storing the updated data when said bit represents said locked state;
means for storing said second thread in a queue, and shifting said second thread to a control state, for a mechanism that performs a waiting operation for accessing said specific object and a recovery operation by transmitting a notification;
means for storing said bit that represents said locked state in said storage area before said first thread unlocks said object;
means for determining whether a thread that is stored in a queue is present;
means for shifting said first thread to a notification state, wherein said transmission of a notification to said thread that is waiting is initiated, when a thread that is stored in a queue is present; and
means for permitting said first thread to exit said notification state.

15. The lock management apparatus according to claim 14, further comprising:
means for increasing, when said bit that represents said locked state is set, the number of queues of threads that can access said specific object and storing the updated number, and determining whether said bit that represents said lock on said specific object represents said locked state; and
means for reducing, when said bit that represents said locked state is not set, the number of said queues of said threads that access said specific object and storing the updated number, and terminating a locking process without any other process being performed.

16. In a shared memory model system, an apparatus where, in a state wherein a plurality of threads exist, a bit that represents a lock is stored in a storage area that corresponds to an object, and a queue of threads that access said object is stored to manage a lock on an object, said apparatus comprising:
means for determining, when a second thread attempts to acquire a lock on a specific object that a first thread has locked, whether a bit that represents said lock on said object represents the locked state;
means for changing, when said bit represents said locked state, data for the number of queues of threads that can access said specific object and storing the updated data, and thereafter issuing a synchronization command for said storage area;
means for storing said second thread in a queue, and shifting said second thread to a control state for a mechanism that performs a waiting operation, for accessing said specific object, and a recovery operation by transmitting a notification;
means for storing in said storage area, before said first thread unlocks said object, said bit that represents said locked state and an identifier that is not related to the representation of said locked state or an unlocked state;
means for issuing a synchronization command for said storage area;
means for storing, in said storage area, data that does not represent said lock on said specific object;
means for determining whether a thread that is stored in a queue is present;
means for shifting, when a thread that is stored in a queue is present, said first thread to a notification state wherein said transmission is initiated for issuing a notification to said thread that is waiting; and
means for permitting said first thread to exit said notification state.

17. The lock management apparatus according to claim 16, further comprising:
means for increasing, when said bit that represents said locked state is set, the number of queues of threads that can access said specific object and storing the updated number, and determining whether said bit that represents said lock on said specific object represents said locked state; and
means for reducing, when said bit that represents said locked state is not set, the number of said queues of said threads that access said specific object and storing the updated number, and terminating a locking process without any other process being performed.

18. The lock management apparatus according to claim 17, further comprising:
means for permitting said second thread, when said bit that represents said locked state is set and when an identifier that is not related to the representation of said locked state or said unlocked state is stored in said storage area, to remain in a busy waiting state until a thread that maintains said lock on said object is no longer present and said bit that represents said locked state is changed to represent said unlocked state.
